(19) United States
(12) Patent Application Publication
(10) Pub. No.: US 2023/0029345 A1
(43) Pub. Date: Jan. 26, 2023

(54) INCREMENTAL-PRICED FUNDING ROUNDS

(71) Applicant: Marc R. DESCHENAUX, Geneva (CH)

(72) Inventor: Marc R. DESCHENAUX, Geneva (CH)

(21) Appl. No.: 17/871,100

(22) Filed: Jul. 22, 2022

Related U.S. Application Data
(60) Provisional application No. 63/224,688, filed on Jul. 22, 2021.

(51) Int. Cl. G06Q 40/04

(52) U.S. Cl. CPC G06Q 40/04; G06Q 20/389

(57) ABSTRACT

A computerized system with hardware and specialized software components for developing, executing and administering multi-priced funding, the system providing a of first price category shares that can be purchased at a first price and a plurality of second price category shares that can be purchased at a second price at an incrementally higher offering price than the first price, wherein the second price category shares are offered for sale at a time after the first price category shares are sold and purchasers of the first price category shares can sell the first price category shares to purchasers of the second price category shares at the second price.

### CROSS REFERENCE TO RELATED APPLICATIONS

This application claims the benefit of U.S. Provisional Application Ser. No. 63/224,688 filed Jul. 22, 2021, the contents of which are incorporated herein in their entirety.

### FIELD OF THE DISCLOSURE

Systems and methods are disclosed which generally relate to raising private equity or venture capital by offering equity securities in companies.

### BACKGROUND

Previously, methods of raising investment capital included the funding rounds method. Each time a securities issue was needed, a fixed price for each share of the security was determined according to the current state and valuation of the company for which the security was issued and was offered to investors. With a single fixed price, if the company was mismanaged or could not achieve its initial objectives or was simply running out of money, the fixed price would need to be lowered to attract new investors. New investors could buy shares of stock at a lower price than the earlier investors, while new investors still have less risk than the earlier investors. All investors wanted to be the last and not the first to invest, so the process was extremely slow.

It is desirable to increase the pace of investment and stabilize equity funding rounds so that raising capital can be more efficient and provide more equitable assumption of risk. The principle of equality not only states that every investor in the same situation must be treated equally, but also that every investor in a different situation must be treated differently. Except for a few exceptional cases, when an investor invests several months or more than one year after another, he or she cannot possibly be in the same situation as one who invested several months or less than one year ago. Therefore, early investors should be rewarded for assuming higher risk than later investors. Thus it is right for new investors to pay a premium over earlier investors.

### SUMMARY

One aspect of the disclosed subject matter provides a method for providing multi-priced funding, the method comprising: providing a first round of shares of equity in a private company, wherein each share in the first round is available for purchase by one or more first investors at a first fixed price, wherein the first round of shares at the first fixed price become unavailable when a first threshold of capital is raised, and providing a second round of shares of equity in the same company, wherein each share in the second round is available for purchase by one or more second investors at a second fixed price immediately after the first shares are unavailable, the second fixed price being greater than the first fixed price associated with the first round of shares, and further wherein the one or more first investors have an option to offer their first shares at the greater price.

Embodiments of the above method include the following, alone or in any combination.

The second round of shares are available for investment by the one or more second investors until a second threshold of capital is raised.

The first threshold of capital represents a first percentage of a target valuation of the company.

The second threshold of capital represents a second percentage of a target valuation of the company.

The first and second thresholds represent 100% of the target valuation of the company.

The method may include a third round of shares of equity at a third price, the third price being greater than the second price associated with the second round of shares. Notably, the third round of shares are available only when a second threshold of capital is raised. Each of the first and second investors have the option to trade their shares to investors at the third price. In some instances, the one or more first investors may resell the first shares to one or more second investors; or the one or more first or second investors may resell the first or second shares of equity to the company.

In another aspect, the method can be conducted by a distributed networked computer system. The method may comprise a central processor receiving, from a first networked node, a first bid for one or more shares of a first round of shares from a first investor; determining a fractional amount of the shares of the first round to allocate to the first investor based on the first bid; determining that a first threshold of capital is raised and closing availability of the first round of shares; providing a second round of shares for sale to a second investor immediately after the first threshold is reached; receiving, from a second networked node, a second bid for one or more shares of the second round of shares from the second investor; allocating, by one or more processors, the fractional amount of the first round of shares to the first inventor and the fractional amount of shares of the second round to the second inventor; recording in a distributed ledger, wherein the distributed ledger is accessible by the first networked node and the second networked node, bids for the one or more shares of the first round of shares and the one or more shares of the second round of shares; respective allocated shares determined by the central processor; and execution of a smart contract accessible to the first networked node and the second networked node, wherein the smart contract comprises: acceptance, by the private company, of the bids from the first investor and the bids from the second investor; and a plurality of predetermined electronic actions for generating a smart contract output when the bids are accepted, wherein the smart contract generates terms and conditions between the private company and the first investor and between the private company and the second investor automatically based on whether the shares are from the first round or second round.

Embodiments of the method conducted by the distributed networked computer system include the aforementioned embodiments of the method, alone or in any combination.

Another aspect provides a distributed networked computer system for providing multi-priced venture funding of equity in a private company, the distributed network computer system comprising a non-transitory computer readable storage medium having program instructions embodied therewith; and one or more processors configured to execute the program instructions to cause the computer system to: receive by a central processor, from a first networked node, a first bid for one or more shares of a first round of shares in the private company from a first investor; determine a fractional amount of the shares of the first round to allocate to the first investor based on the first bid; determine that a first threshold of capital is raised and closing availability of the first round of shares; provide a second round of shares in the private company for sale to a second investor after the first threshold is reached; receive, from a second networked node, a second bid for one or more shares of the second round of shares from the second investor; allocate, by one or more processors, the fractional amount of the first round of shares to the first inventor and the fractional amount of shares of the second round to the second inventor; a distributed ledger for recording bids for the shares and respective allocated shares determined by the central processor, wherein the distributed ledger is accessible by the first networked node and the second networked node; and a smart contract accessible to the first networked node and the second networked node, wherein the smart contract comprises acceptance, by the private company, of the bids from the first investor and the bids from the second investor; and a plurality of predetermined electronic actions for generating a smart contract output when the bids are accepted, wherein the smart contract generates terms and conditions between the private company and the first investor and between the private company and the second investor automatically based on whether the shares are from the first round or second round; and further wherein the execution of the smart contract is recorded to the distributed ledger.

Embodiments of the distributed networked computer system include the following, alone or in any combination.

Each share in the first round is available for purchase by one or more first investors at a first fixed price, wherein the first round of shares at the first fixed price become unavailable when the first threshold of capital is raised, and wherein each share in the second round is available for purchase by one or more second investors at a second fixed price, the second fixed price being greater than the first fixed price associated with the first round of shares, and further wherein the one or more first investors have an option to offer their first shares at the greater price.

The first threshold of capital represents a first percentage of a target valuation of the company.

The second round of shares are available for investment by the one or more second investors until a second threshold of capital is raised.

The second threshold of capital represents a second percentage of a target valuation of the company.

The instructions cause the distributed networked computer system to provide a third round of shares of equity at a third price, the third price being greater than the second price associated with the second round of shares. The third round of shares may be available only when a second threshold of capital is raised.

Another aspect provides a non-transitory computer readable storage medium comprising a plurality of computer readable instructions embodied thereon wherein the instructions, when executed by a distributed networked computer system for providing multi-priced venture funding of equity in a private company, cause the distributed networked computer system to cause a central processor to receive, from a first networked node, a first bid for one or more shares of a first round of shares in the private company from a first investor; determine a fractional amount of the shares of the first round to allocate to the first investor based on the first bid; determine that a first threshold of capital is raised and closing availability of the first round of shares; provide a second round of shares in the private company for sale to a second investor after the first threshold is reached; receive, from a second networked node, a second bid for one or more shares of the second round of shares from the second investor; allocate, by one or more processors, the fractional amount of the first round of shares to the first inventor and the fractional amount of shares of the second round to the second inventor; and record in a distributed ledger, wherein the distributed ledger is accessible by the first networked node and the second networked node, bids for the one or more shares of the first round of shares and the one or more shares of the second round of shares; respective allocated shares determined by the central processor; and execution of a smart contract accessible to the first networked node and the second networked node, wherein the smart contract comprises acceptance, by the private company, of the bids from the first investor and the bids from the second investor; and a plurality of predetermined electronic actions for generating a smart contract output when the bids are accepted, wherein the smart contract generates terms and conditions between the private company and the first investor and between the private company and the second investor automatically based on whether the shares are from the first round or second round.

Embodiments of the non-transitory computer readable storage medium include the following, alone or in any combination.

Each share in the first round is available for purchase by one or more first investors at a first fixed price, wherein the first round of shares at the first fixed price become unavailable when the first threshold of capital is raised, and wherein each share in the second round is available for purchase by one or more second investors at a second fixed price, the second fixed price being greater than the first fixed price associated with the first round of shares, and further wherein the one or more first investors have an option to offer their first shares at the greater price.

The first threshold of capital represents a first percentage of a target valuation of the company.

The second round of shares are available for investment by the one or more second investors until a second threshold of capital is raised.

The second threshold of capital represents a second percentage of a target valuation of the company.

The instructions may cause the distributed networked computer system to provide a third round of shares of equity at a third price, the third price being greater than the second price associated with the second round of shares. The third round of shares may be available only when a second threshold of capital is raised. Each of the first and second investors have the option to trade their shares to investors at the third price. In some instances, the one or more first investors may resell the first shares to one or more second investors; or the one or more first or second investors may resell the first or second shares of equity to the company.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1A depicts a chart of first and second price categories according to an exemplary embodiment of the disclosed subject matter.

FIG. 1B depicts a chart of five price categories according to an exemplary embodiment of the disclosed subject matter.

FIG. 1C depicts a chart of five price categories according to an exemplary embodiment of the disclosed subject matter.

FIGS. 2A-2B depict schematic functional diagrams of a computer system relating to planning and developing securities, modeling and evaluating alternatives, as well as executing and administering an offering for sale of securities according to an exemplary embodiment of the disclosed subject matter.

FIG. 3 depicts a functional diagram of components of a computer system according to an exemplary embodiment of the disclosed subject matter.

FIG. 4 shows a process flow diagram for defining and offering for sale a first tranche of a multi-price share offering with incremental price increases according to an embodiment of the disclosed subject matter.

FIG. 5 shows a process flow diagram for offering for sale of subsequent tranches of a multi-price share offering with incremental price increases according to an embodiment of the disclosed subject matter.

FIGS. 6A and 6B are schematic diagrams illustrating example embodiments of a system comprising nodes and users that may be involved in a distributed networked system utilizing one or more smart contracts on a distributed ledger technology platform offering for sale and administering an intellectual property security in accordance with disclosed subject matter.

### DETAILED DESCRIPTION OF THE DISCLOSED SUBJECT MATTER

The multi-priced funding systems and methods described herein allow for increasing the pace of investment and stabilizing private equity funding rounds so that raising capital can be more efficient and provide more equitable assumption of risk. The multi-pricing allows investors to tailor their risk tolerance by providing a measure of reward for investing early and assuming more risk. Later investors, knowing that a certain amount of funding has already been obtained from early investors, can be encouraged to invest with some assurance that the venture will be adequately funded. Further, use of a distributed networked computer system facilitates interaction among representatives of a private company seeking investment and potential investors.

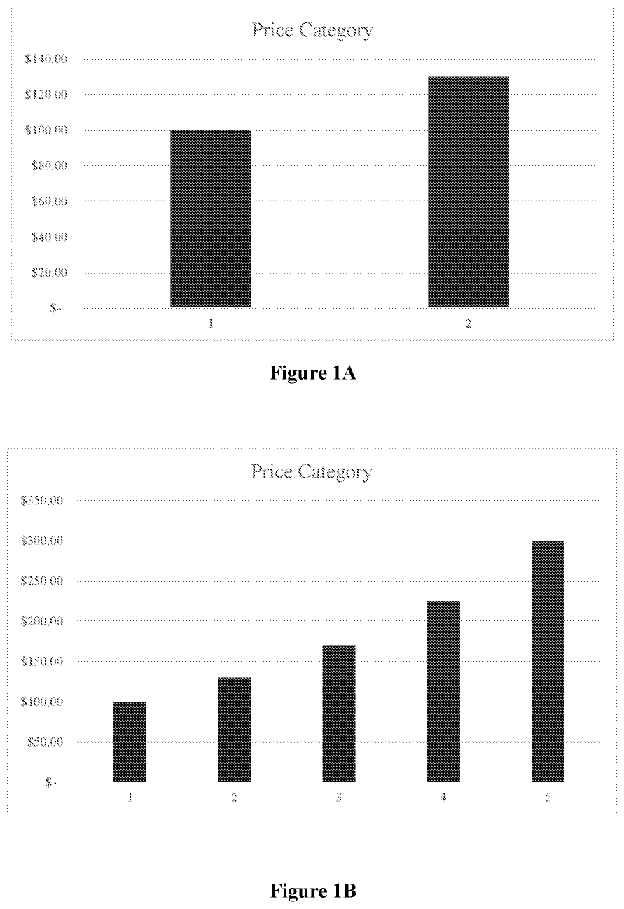

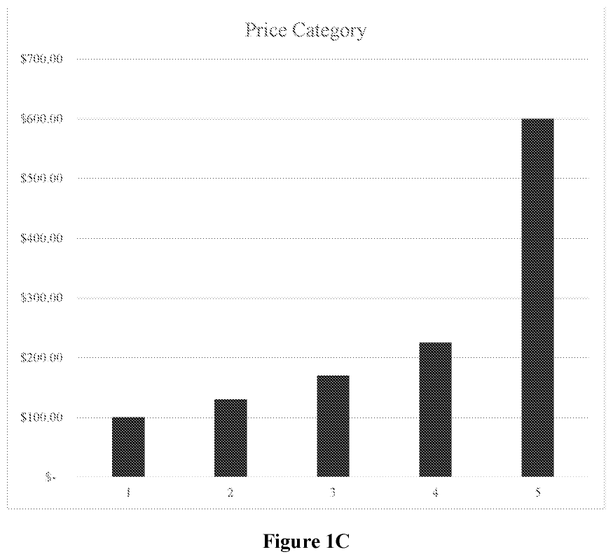

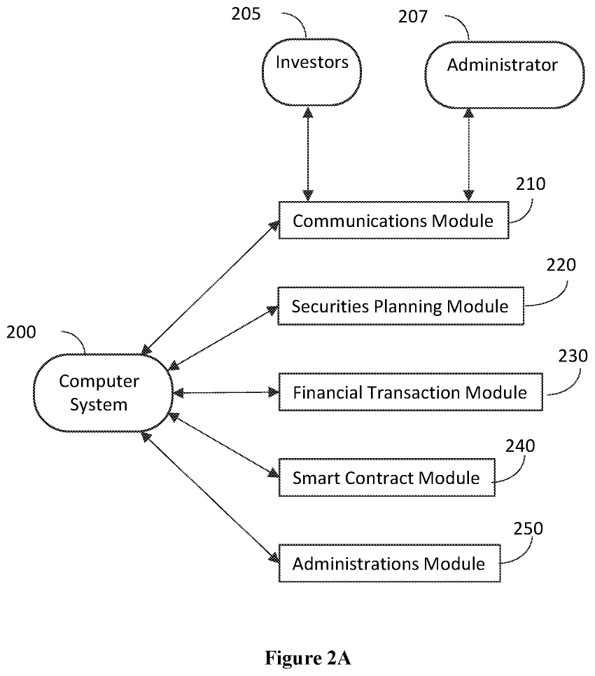

The multi-priced venture funding comprises a multi-round method of financing wherein a plurality of two or more price categories wherein tranches of price categories are sequentially offered at incrementally increasing prices, wherein each tranche is calculated to raise a known percentage of a target valuation to be raised. FIG. 1A illustrates a model multi-priced venture funding regime comprising two tranches or rounds of price categories. For example but not limitation, the price of each tranche increases at least 30% over the previous tranche. In this example, the first price category may be initially offered at $100 per share and the second price category is offered at $130 per share. The amount of shares in the price categories may be the same or different. The percentage of revenue raised by each tranche may also be the same or different.

Optionally, the issue of securities, for example the total number of shares, is divided into three to five (or more) tranches, as illustrated in FIG. 1B. In this exemplary embodiment, the price per share of the tranches increases at roughly 30% increments, rising from $100 per share in the first tranche to $300 per share. In some embodiments such as shown in FIG. 1B, the number of shares and the price per share increase in the tranches may be relatively fixed.

In other embodiments, the percentage of price increase and the number of shares may be variable. For example, in embodiments, the number of shares and the price increase may be fixed in the first four tranches, while the fifth tranche may have a significantly higher number of shares than the other tranches and a significantly higher price per share. This embodiment may be used when the offering is particularly popular, allowing for many investors to invest in the offering once a threshold level funding is attained in the early tranches. FIG. 1C shows an embodiment wherein the first four tranches have a price increase of 30% at each tranche, while the price increase between the fourth and fifth tranches is 167%, from $225 to $600 per share.

Splitting the offering into a plurality of tranches may incentivize early investing, where the rewards of early investing translate into a higher percentage of holdings in the company. For example, shares in the first tranche may be weighted to give early investors a higher percentage of shares in the venture than later tranches. This may encourage investors to bid up the first tranche price to ensure that they get a preferred position compared to investors in the later tranches.

For example, in a private offering, the first round may be considered a seed round in which a company secures capital to finance its first steps, including things like market research and product development. Potential investors in a seed funding situation may include founders, friends, family, angel investors, incubators, and more. An angel investor usually is a wealthy former entrepreneur or professional who provides starting or growth capital in promising ventures, and helps also with advice and contacts. Unlike venture capitalists, angel investors usually operate alone (or in very small groups) and play only an indirect role as advisors in the operations of the investee firm. Angel investors tend to appreciate riskier ventures (such as startups with little by way of a proven track record so far) and expect an equity stake in the company in exchange for their investment.

The second round may attract investors such as venture capital firms or private equity firms. “Venture capitalists” are private investors, typically operating in organized firms, who provide venture capital to promising business ventures. Typically, the funds sought would be used to proceed with expansion plans. The company may likely need to provide the potential investors with detailed information on their business model and projections for future growth and revenue.

When a new tranche is sold, the investors who invested in a previous tranche that want or need to exit can sell some or all of their securities at a profit to new investors at the same new price or slightly below. The main advantage is that if the company is mismanaged or could not achieve its initial objectives or is simply running out of money, new investors will still buy shares of stock at a higher price than the earlier investors who took the biggest risk. Early investors in the first tranche have some confidence that they may be able to exit the venture by selling to later investors at a profit.

To manage their risk, investors may invest all their capital in one tranche or may spread their capital into multiple tranches. For example, early investors in the first tranche may also buy more shares in subsequent tranches as others also invest. Other investors may want to wait until later tranches are offered, so that they have assurance that the venture is adequately funded by the earlier tranches.

In many instances, the start-up company does not have sufficient expertise and/or resources to value, underwrite, issue and administer securities. In such instances, the start-up company may engage with a Security Management Company (“SMC”), which as used herein is an “issuer,” to manage the offering. The SMC may manage the offering in return for an equity position in the start-up company and/or transaction fees. Notably, the SMC has resources to set up and maintain computer systems for managing the offering. The Securities Management Company may manage offerings for a plurality of companies seeking capital and offer shares in the companies to a plurality of investors. In embodiments the computer system may comprise a distributed networked system to manage interactions among investors and private companies.

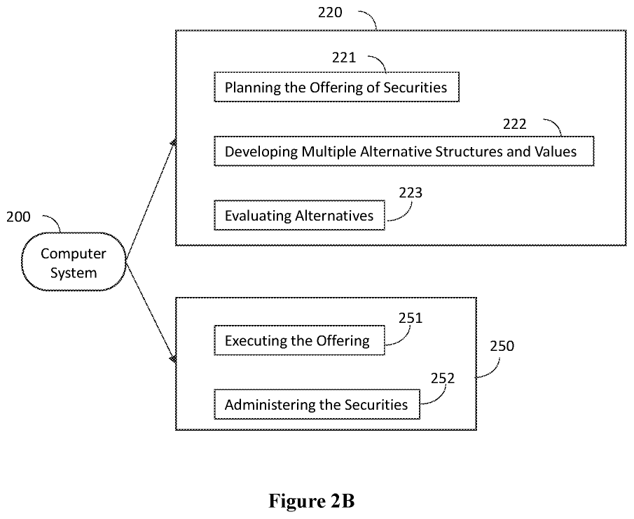

As shown in FIG. 2A, a computer system 200 is a core element of the architecture for offering shares to raise capital for a venture, such as a start-up company (as used herein, a “seller”), receiving, generating, storing, integrating and coordinating data required for defining an offering, receiving investment payments from a plurality of investors 205, matching bids from the plurality of investors, generating smart contracts among investors and the company (seller) or issuer, and defining terms and conditions for the shares in the different funding rounds and administering payouts to the start-up company and investors. The computer system is further provided with at least one processor into which is loaded software components for receiving informational inputs from the plurality of investors and at least one bank or other financial institution that organizes an issue of new shares for a venture via communications module or interface 210.

Block 210 represents a communication module, which manages inputs from investors and transmits outputs to the investors. Inputs from investors include investing information, investor identity, designation of a payment vehicle or digital “wallet”, such as a credit or debit account, including credit or debit cards issued by a financial institution, Venmo® or Pay Pal® apps, etc. Communications module 210 may also be used by administrator(s) 207 of the computer system to communicate with the system. Administrator(s) may provide inputs to the system to maintain and manage the system to make sure it is operating correctly. In embodiments, the administrator(s) 207 may also provide inputs to the system to designate shares for investors to invest in, risk assessments, projected revenue, etc.

In block 220, the system includes a securities planning module in which the securities (shares in the company) are defined, as described in greater detail in regard to FIG. 2B.

Block 230 comprises the financial transactions module that manages payments from investors to cover their bids, payments to the start-up company (seller) and collection of transaction fees. In embodiments, once a bid is accepted, the financial transactions module may withdraw the bid amounts plus transaction fees from investors' payment vehicles in response to acceptance of bids by the computer system. Block 230 may also disburse future payments to the investors based on the terms of the securities.

In embodiments, the shares may be offered in the form of a smart contract, described in greater detail below. In block 240, the smart contract module executes smart contracts by generating data blocks defining the shares in each funding round, including all terms and conditions binding on the investors and the company such as purchase prices, revenue payouts to the investors, etc. Terms and conditions may also comprise aspects of company actions based on inputs from the investors.

Block 250 shows the securities administration module, which executes and administers the securities.

As shown in FIG. 2B, block 220 comprises aspects of defining the share offerings in each round of the funding regime.

In block 221, planning the offering of securities includes establishing the target amount of capital to be raised. Guided by inputs from administrator(s) of the system from a bank, broker, underwriter and/or other financial institutions, the system conducts feasibility studies for offering tranches of multi-priced shares in at least two funding rounds to define the structure of the offering. The offering planning includes specific variables to be included, ranges of acceptable values for each variable, and terms and conditions to be included in the offering.

In block 222, the system models and projects multiple values of individual variables and combinations of multiple sets of variables, such as time series projections and economic modeling of interaction among variables.

In block 223, the system evaluates alternatives by reviewing results of modeling and projections. Selecting one or more sets of variables that meet targets will be used to refine the structure and value of variables and terms and conditions for price categories of the shares in each funding round. Additional modeling and projections may be required to define a preferred set of values for the variables and terms and conditions for inclusion in the offering of securities in the price categories of the shares in each of the funding rounds. When initiated by a buyer, the buyer may input a desired type of security and the system may generate securities based on the defined characteristics. The Securities Management Company may aggregate capital requests from a plurality of sellers to define a pool of opportunities based on a technology sector, size of the opportunities, etc.

FIG. 2B also shows block 250 comprising aspects of administering the security offerings in the funding rounds.

In block 251, the system executes the offering of the securities. The price and content of the individual shares of the price category tranches are established. Technical and legal details are finalized and the securities are brought to market. The system receives and accepts bids for shares in each funding round from at least one investor, tracks progress of sales of shares within each round, and closes sales in a round when target values are met. The system also receives sell orders from holders of shares from early tranches when subsequent tranches are opened and sells them to new investors.

Block 251 may comprise an order creation module. In general, the order creation module may have two modes of functionality. In a first mode, the order creation module permits a buyer (investor) to search a database of investment opportunities among a plurality of companies seeking capital and to select one or more ventures from the inventory for pricing by a selected group of sellers. It will be understood from the following disclosure that, although multiple pools are selected, any number of pools less than the total number selected (or none at all) may be quoted and ultimately traded. In a second mode, a buyer is provided with the option to select the characteristics of a desired specified pool. These characteristics may be transmitted through system 200 to one or more sellers. The sellers can identify one or more pools in their respective inventories that substantially meet the buyer's specified set of characteristics or agree to create a specified pool meeting such characteristics.

In operation, by setting various criteria and through selection of one or more sellers, through the operation of the order creation module, buyers can create a customized inventory query which will return available investment opportunities from database(s) in the system. In the alternative, the query can be submitted directly to the seller in order to determine whether the seller has or can stipulate to an asset security meeting the buyer's requirements. This feature may be used when a security meeting the buyer's requirements is not in the inventory of one or more sellers.

In an alternative embodiment, wherein one or more desired investment opportunities are not in an inventory of offered funding requests, a buyer (investor) may be enabled to send an inquiry message to the SMC inquiring as to the availability of an investment opportunity that suits the buyer's needs. In this embodiment, a buyer typically creates an order query using system 200's order creation module to determine whether a desired opportunity is listed in the system's database of securities previously populated by one or more sellers. Such query details may include, title(s) or other identifier(s) of assets, a technology sector, a weighted average maturity, a constant payment rate, an originator identifier, etc. While the buyer may use various inventory filters to enable the buyer to search for opportunities meeting defined criteria, in some instances, the desired security may not be available. In those instances, the buyer can define the criteria according to which an inquiry message will be generated and transmitted to one or more sellers via the distributed system. A dealer or agent list may include a list of dealers, acting as sellers, and aspects of the buyer interface enable the buyer to select the dealers to which the inquiry message will be transmitted. Once the buyer completes the process of inputting desired criteria and selecting dealers, the criteria and dealer data is transmitted to and received by system 200. System 200 then generates an inquiry message which includes the characteristics for the pool of opportunities defined by the buyer. The data in the inquiry message is then transmitted to the selected dealer(s).

In block 252, the system administers the securities (shares) in the offering. It maintains detailed and current records of individual investor accounts as required for periodic and cumulative payments, tax treatment, benefits, reports and other purposes. It maintains required and useful records related to financial analysis and financial reports of investors, brokers, and other involved parties. In embodiments, at least some of the records are recorded in a distributed ledger such as a blockchain.

In embodiments, the offering, sale and administration of the shares may be conducted as a smart contract.

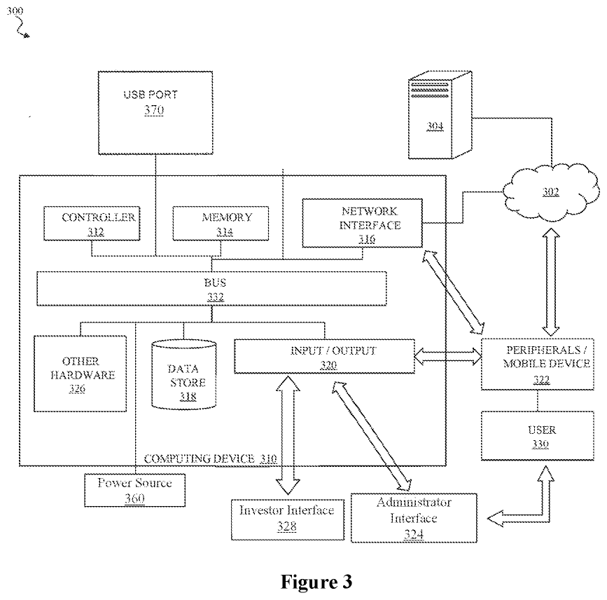

FIG. 3 depicts a computer system 300 according to an embodiment of the present disclosure. In general, the computer system 300 may include a computing device 310, such as a special-purpose computer designed and implemented for receiving user inputs, determining and directing and controlling the output of signals. The computing device 310 may be or include data sources, client devices, and so forth. In certain aspects, the computing device 310 may be implemented using hardware or a combination of software and hardware. The computing device 310 may be a standalone device, a device integrated into another entity or device, a platform distributed across multiple entities, or a virtualized device executing in a virtualization environment.

The computing device 310 may communicate across a network 302. The network 302 may include any data network(s) or internetwork(s) suitable for communicating data and control information among participants in the computer system 300. This may include public networks such as the Internet, private networks, and telecommunications networks such as the Public Switched Telephone Network or cellular networks using cellular technology and/or other technologies, as well as any of a variety other local area networks or enterprise networks, along with any switches, routers, hubs, gateways, and the like that might be used to carry data among participants in the computer system 300. The network 302 may also include a combination of data networks and need not be limited to a strictly public or private network.

The computing device 310 may communicate with an external device 304. The external device 304 may be any computer, mobile device such as a cell phone, tablet, smart watch or other remote resource that connects to the computing device 310 through the network 302. This may include any of the servers or data sources described herein, including servers, content providers, databases or other sources for shot information to be used by the devices as described herein.

In general, the computing device 310 may include a controller or processor 312, a memory 314, a network interface 316, a data store 318, and one or more input/output interfaces 320. The computing device 310 may further include or be in communication with peripherals 322 and other external input/output devices that might connect to the input/output interfaces 320.

The controller 312 may be implemented in software, hardware or a combination of software and hardware. According to one aspect, the controller 312 may be implemented in application software running on a computer platform. Alternatively, the controller 312 may include a processor or other processing circuitry capable of processing instructions for execution within the computing device 310 or computer system 300. The controller 312, as hardware, may include a single-threaded processor, a multi-threaded processor, a multi-core processor and so forth. The controller 312 may be capable of processing instructions stored in the memory 314 or the data store 318.

The memory 314 may store information within the computing device 310. The memory 314 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 314 may store program instructions, program data, executables, and other software and data useful for controlling operation of the computing device 310 and configuring the computing device 310 to perform functions for a user 330. The memory 314 may include a number of different stages and types of memory for different aspects of operation of the computing device 310. For example, a processor may include on-board memory and/or cache for faster access to certain data or instructions, and a separate, main memory or the like may be included to expand memory capacity as desired. All such memory types may be a part of the memory 314 as contemplated herein.

The memory 314 may, in general, include a non-volatile computer readable medium containing computer code that, when executed by the computing device 310 creates an execution environment for a computer program in question, e.g., code that constitutes processor firmware, a protocol stack, a database management system, an operating system, or a combination of the foregoing, and that performs some or all of the steps set forth in the various flow charts and other algorithmic descriptions set forth herein. While a single memory 314 is depicted, it will be understood that any number of memories may be usefully incorporated into the computing device 310.

The network interface 316 may include any hardware and/or software for connecting the computing device 310 in a communicating relationship with other resources through the network 302. This may include remote resources accessible through the Internet, as well as local resources available using short range communications protocols using, e.g., physical connections (e.g., Ethernet), radio frequency communications (e.g., Wi-Fi, Bluetooth), optical communications (e.g., fiber optics, infrared, or the like), ultrasonic communications, or any combination of these or other media that might be used to carry data between the computing device 310 and other devices. The network interface 316 may, for example, include a router, a modem, a network card, an infrared transceiver, a radio frequency (RF) transceiver for receiving AM/FM or satellite radio sources, a near field communications interface, a radio-frequency identification (RFID) tag reader, or any other data reading or writing resource or the like.

The network interface 316 may include any combination of hardware and software suitable for coupling the components of the computing device 310 to other computing or communications resources. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple to other local devices, or to connect to a local area network or the like that is in turn coupled to a data network 302 such as the Internet. This may also include hardware/software for a WiMax connection or a cellular network connection (using, e.g., CDMA, GSM, LTE, or any other suitable protocol or combination of protocols). The network interface 316 may be included as part of the input/output devices 320 or vice-versa.

The data store 318 may be any internal or external memory store providing a computer-readable medium such as a disk drive, an optical drive, a magnetic drive, a flash drive, or other device capable of providing mass storage for the computing device 310. The data store 318 may store computer readable instructions, data structures, program modules, and other data for the computing device 310 or computer system 300 in a non-volatile form for relatively long-term, persistent storage and subsequent retrieval and use. For example, the data store 318 may store an operating system, application programs, program data, databases, files, and other program modules or other software objects and the like. At least a portion of the data store 318 may be implemented in a distributed ledger technology such as a blockchain to record transaction information and smart contracts.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

The input/output interface 320 may support input from and output to other devices that might couple to the computing device 310. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also include an infrared interface, RF interface, magnetic card reader, or other input/output system for wirelessly coupling in a communicating relationship with other local devices. It will be understood that, while the network interface 316 for network communications is described separately from the input/output interface 320 for local device communications, these two interfaces may be the same, or may share functionality, such as where a USB port 370 is used to attach to a Wi-Fi accessory, or where an Ethernet connection is used to couple to a local network attached storage. The input/output interface 320 may further output signals to displays of peripheral devices, as described herein.

As used herein, a user 330 is any human that interacts with the computer system 300. In this context, a user may be generally classed within one of several categories. One category is an administrator of the system, representing the financial institution organizing and conducting the offering of the multi-priced financing regime. A second category is a representative of the company seeking investors. Another category is an investor who buys and sells shares in the offering.

In certain embodiments the I/O interface 320 facilitates communication with input and output devices for interacting with a user. For example, the I/O interface may communicate with one or more devices such as a user-input device and/or a display 350 which may be instantiated on the device described herein or on a separate device such as a mobile device 208, which enable a user to interact directly with the controller 312 via bus 332. The user-input device may comprise one or more push-buttons, a touch screen, or other devices that allows a user to input information. In these embodiments, the computer system may further comprise a display to provide visual output to the user. The display may comprise any of a variety of visual displays, such as a viewable screen, a set of viewable symbols or numbers, and so on. One can appreciate that the inputs and outputs of the computer system would be different for administrators and investors. Accordingly, the computing device 310 may communicate administrators and investors with different interfaces 324 and 328.

A peripheral 322 may include any device used to provide information to or receive information from the computing device 310. This may include human input/output (I/O) devices such as a keyboard, a mouse, a mouse pad, a track ball, a joystick, a microphone, a foot pedal, a camera, a touch screen, a scanner, or other device that might be employed by the user 330 to provide input to the computing device 310. This may also or instead include a display, a printer, a projector, a headset or any other audiovisual device for presenting information to a user. The peripheral 322 may also or instead include a digital signal processing device, an actuator, or other device to support control of or communication with other devices or components. In one aspect, the peripheral 322 may serve as the network interface 316, such as with a USB device configured to provide communications via short range (e.g., Bluetooth, Wi-Fi, Infrared, RF, or the like) or long range (e.g., cellular data or WiMax) communications protocols. In another aspect, the peripheral 322 may augment operation of the computing device 310 with additional functions or features, such as another device. In another aspect, the peripheral 322 may include a storage device such as a flash card, USB drive, or other solid-state device, or an optical drive, a magnetic drive, a disk drive, or other device or combination of devices suitable for bulk storage. More generally, any device or combination of devices suitable for use with the computing device 310 may be used as a peripheral 322 as contemplated herein.

Other hardware 326 may be incorporated into the computing device 310 such as a co-processor, a digital signal processing system, a math co-processor, a graphics engine, a video driver, a camera, a microphone, additional speakers, and so forth. The other hardware 326 may also or instead include expanded input/output ports, extra memory, additional drives, and so forth.

A bus 332 or combination of busses may serve as an electromechanical backbone for interconnecting components of the computing device 310 such as the controller 312, memory 314, network interface 316, other hardware 326, data store 318, and input/output interface. As shown in the figure, each of the components of the computing device 310 may be interconnected using a system bus 332 in a communicating relationship for sharing controls, commands, data, power, and so forth.

The computing device 310 is connected to a power source 360 to provide electrical power for the computing device to run.

The various illustrative logical blocks, modules and circuits described in connection with the present disclosure may be implemented or performed with a processor specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Further, it should be appreciated that modules and/or other appropriate systems for performing the methods and techniques described herein can be downloaded and/or otherwise obtained by a user terminal and/or base station as applicable. For example, such a device can be coupled to a server to facilitate the transfer of applications for performing the methods described herein. Alternatively, various methods described herein can be provided via storage system, such that a user terminal and/or base station can obtain the various methods upon coupling or providing the storage system to the device. Moreover, any other suitable technique for providing the methods and techniques described herein to a device can be utilized.

The computer program controls input and operation of the device. The computer program includes at least one code segment stored in or on a computer-readable medium residing on or accessible by the device for instructing the computing element, and any other related components to operate in the manner described herein. The computer program is preferably stored within the memory and comprises an ordered listing of executable instructions for implementing logical functions in the device. However, the computer program may comprise programs and methods for implementing functions in the device that are not an ordered listing, such as hard-wired electronic components, programmable logic such as field-programmable gate arrays (FPGAs), application specific integrated circuits, or other similar or conventional methods for controlling the operation of electrical or other computing devices.

Similarly, the computer program may be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. The computer-readable medium may even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

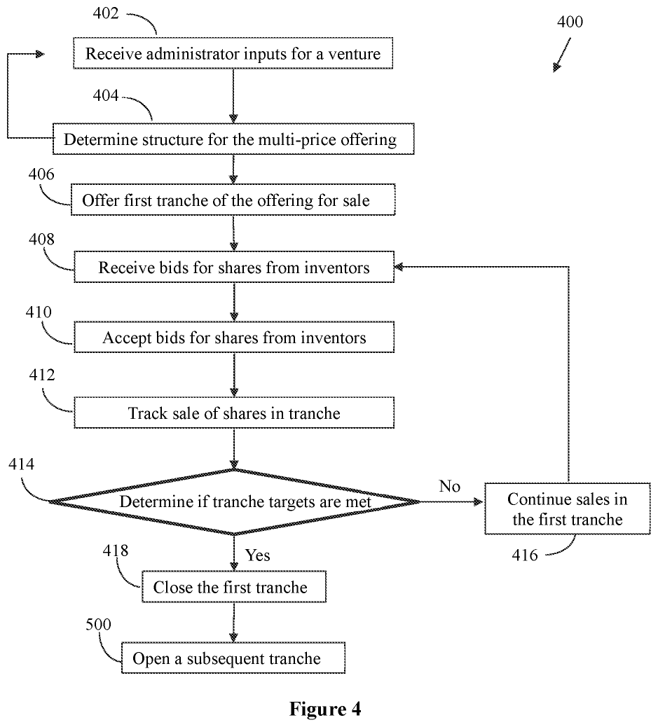

FIG. 4 shows a process flow diagram 400 for defining and offering for sale a first tranche of a multi-price share offering with incremental price increases according to an embodiment of the disclosed subject matter.

The process flow diagram 400 starts at block 402 wherein the computer system receives inputs from administrator(s) regarding a venture to be funded by a multi-price share sale as described herein. Inputs include a target amount of capital to be raised, information regarding the venture's current assets, the current state and valuation of the venture and prospectus for obtaining new assets, etc.

The computer system determines a structure for the multi-price offering in block 404. The determination of the structure comprises conducting activities in blocks 221, 222 and 223 of FIG. 2B. It is to be appreciated that defining the structure of the offering in block 404 may comprise several iterative interactions between the computer system and administrator(s) to define the final structure of the offering.

Once the final structure of the offering is determined, the computer system moves to executing the offering (block 251 of FIG. 2B) by moving to block 406. Block 406 comprises offering the first tranche of shares in the first price category for sale to potential investors. Block 408 comprises receiving bids for shares from investors. Block 410 comprises accepting the bids from investors. Accepting the bids includes issuing shares to the investors at their bid price(s) and holding them in the computer system.

The system tracks the sales of shares in block 412, including the total number of shares sold and the prices offered in bids and accepted by the computer system. As the computer system tracks share sales it determines whether targets of the first tranche have been met in block 414. Targets may include shares in the first tranche being sold out, bid prices reaching a target price related to the offering price of the second tranche, target funding raised, time period for offering the first tranche expiring, or any combination thereof. If the target(s) are not reached, the computer system moves to block 416 to continue offering shares in the first offering, returning to block 408 and receiving more bids from investors.

If the computer system determines that the target(s) are reached in block 414, the computer system moves to block 418 and closes the first tranche. After closing the first tranche, the computer system moves to block 500 to open and offer a second (subsequent) tranche. As discussed above, the second tranche is offered at a higher price per share than the first tranche.

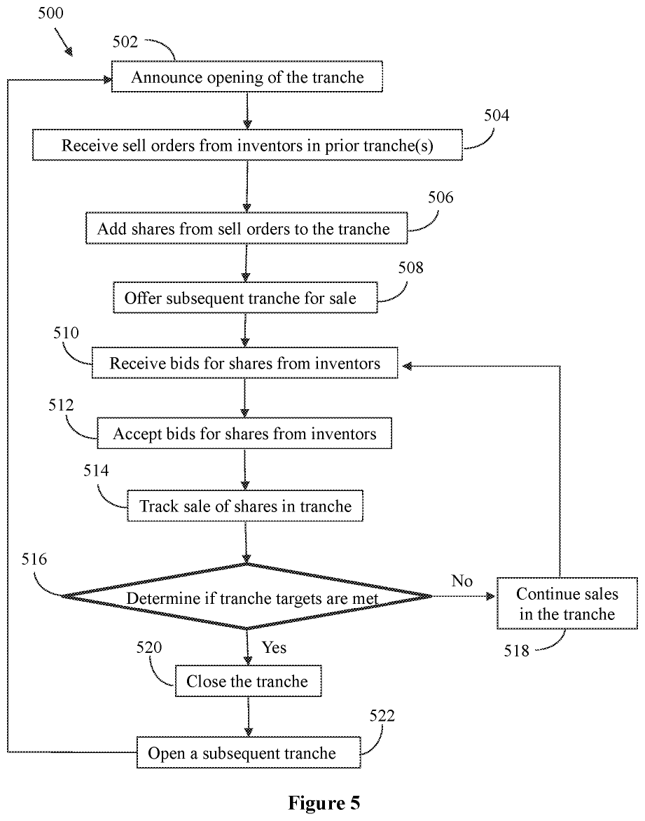

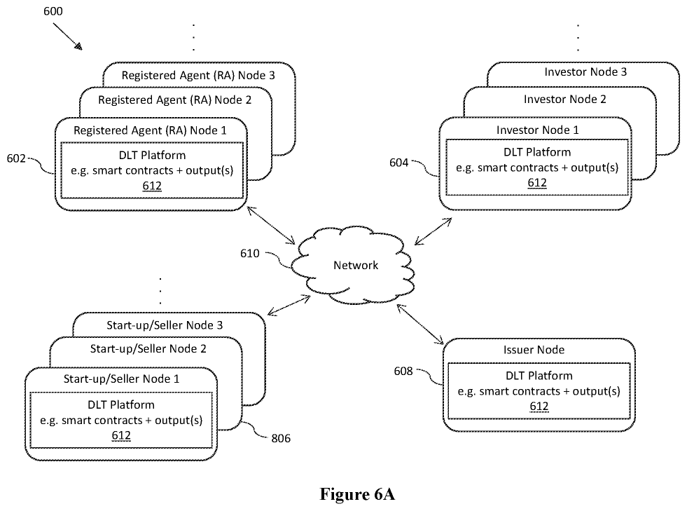

FIG. 5 shows a process flow diagram for offering for sale of subsequent tranches of a multi-price share offering with incremental price increases. FIG. 5 shows the process 500 for opening and offering for sale of the second tranche and any other subsequent tranches.

In block 502, the computer system announces the opening of the second or subsequent tranches, which includes setting the opening asking price of the tranche. In block 504, the computer system receives sell orders for shares bought in the prior tranches from owners of shares wishing to sell shares. When the tranche is the second tranche the first tranche is the prior tranche. When the subsequent tranche is the third tranche the first tranche and the second tranche are the prior tranches, etc. In block 506, the computer system add the shares designated in the sell orders in block 504 to the subsequent tranche for sale to new investors at the new increased sale price. New investors may include investors who had not participated in the prior tranche and/or investors in the prior tranche who wish to increase their holdings. In block 510, the computer system receives bids for shares from investors. Bids can be made for the shares from the prior tranche or from the current tranche. Block 512 comprises accepting the bids from investors. Bids for shares from prior tranches are accepted first, then bids for shares from the current tranche. Accepting the bids includes issuing shares to the investors at their bid price(s) and holding them in the computer system.

The system tracks the sales of shares in block 514, including the total number of shares sold and the prices offered in bids and accepted by the computer system. As the computer system tracks share sales it determines whether targets of the current tranche have been met in block 516. Targets may include shares in the prior and current tranche(s) being sold out, bid prices reaching a target price related to the offering price of a subsequent tranche, target funding raised, time period for offering the current tranche expiring, or any combination thereof If the target(s) are not reached, the computer system moves to block 518 to continue offering shares in the tranche, returning to block 510 and receiving more bids from investors.

If the computer system determines that the target(s) are reached in block 516, the computer system moves to block 520 and closes the current tranche. After closing the current tranche, the computer system moves to block 522 to open and offer a subsequent tranche by returning to block 502 to announce opening of the subsequent tranche. As discussed above, the subsequent tranche is offered at a higher price per share than the current tranche. The process of opening and closing tranches summarized in process flow 500 is continued until all shares in all planned tranches are sold to investors. When all shares are sold, the computer system will end the process in block 520.

While the final tranche may be closed, the computer system may continue administering shares for the investors, allowing them to buy and sell shares within the system. If it is desirable to raise additional capital for the venture, the process flow may return to block 402 for the computer system to define a new tranche or tranches to be offered.

In embodiments, the offering, sale and administration of the shares may be conducted as a smart contract.

A smart contract is a computer application simulating the operation of a contract. It is a computer program or a transaction protocol which is intended to automatically execute, control or document legally relevant events and actions according to the terms of a contract or an agreement between or among parties. The objectives of smart contracts are the reduction of need in trusted intermediators, arbitrations and enforcement costs, fraud losses, as well as the reduction of malicious and accidental exceptions. The smart contract is stored on a distributed ledger such as a blockchain that runs when predetermined conditions are met. Distributed ledger technology (DLT) is a digital system for recording the transaction of assets in which the transactions and their details are recorded in multiple places at the same time. Unlike traditional databases, distributed ledgers have no central data store or administration functionality. They may be used to automate the execution of an agreement so that all participants can be immediately certain of the outcome, without any intermediary's involvement or time loss.

The reliability of the smart contract comes from its automaticity which gives it a power of execution unmatched to date.

A smart contract also can be regarded as a secured stored procedure as its execution and codified effects like the transfer of some value between parties are strictly enforced and cannot be manipulated, after a transaction with specific contract details is stored into a blockchain or distributed ledger. That is because the actual execution of contracts is controlled and audited by the platform, not by any arbitrary server-side programs connecting to the platform. Smart contracts are particularly useful for managing exchanges of virtual financial or value assets, where no tangible materials need to be moved.

A blockchain is a distributed ledger technology that enables a set of peers to work together to create a unified, decentralized network. The peers can communicate and share information or data with the help of a consensus algorithm. There is no need for a centralized authority, which makes the whole network trustworthy when compared to other networks. When one peer sends information to another, a transaction is generated in the form of a “block”. Blocks are used to store transactions and other important information that is required to operate the blockchain successfully. When this happens, the transactions need to be validated using the consensus algorithm. Proof of Work is used to validate the work. It ensures that no invalid transactions are passed into the blockchain. Timestamps are created to ensure that each transaction can be traced, backed, and verified by anyone. The blockchain provides transparency, immutability, and security.

The contracting parties program the contractual terms, payments to be made and all dispatches of documents used for the execution of the contract in the software application and may no longer retract their commitments. Once launched, the application performs the scheduled operations without human intervention, as scheduled or triggered by a defined triggering event.

End clients interact with a smart contract through transactions. Such transactions with a smart contract can invoke other smart contracts. These transactions might result in changing the state and sending financial assets from one smart contract to another or from one account to another. Financial assets can include nationally denominated currencies, cryptocurrencies, virtual stock certificates, or other asset whose value can be defined digitally.

Similar to a transfer of value on a blockchain, deployment of a smart contract on a blockchain occurs by sending a transaction from a wallet for the blockchain. The transaction includes the compiled code for the smart contract as well as a special receiver address. That transaction must then be included in a block that is added to the blockchain, at which point the smart contract's code will execute to establish the initial state of the smart contract. Byzantine fault-tolerant algorithms secure the smart contract in a decentralized way from attempts to tamper with it. Once a smart contract is deployed, it cannot be updated. Smart contracts on a blockchain can store arbitrary state and execute arbitrary computations.

The reliability of the smart contract can be greatly increased by relying on a decentralized IT environment allowing secure access to the contractors and unfalsifiable by them.

Each smart contract may include information about the investment in the shares in each round. Such information may include the identities of the parties, the amount of the investment, triggering events, projected revenue, the time the investment is agreed upon, etc. Investment information may further include conditional outcomes based upon each potential outcome, including the facilitation of payment from the seller to the investor, and/or the return of funds in event of a void or cancellation. In some embodiments, a settlement service may be agreed upon among the parties.

Some embodiments provide that the smart contracts may be generated on individual personal computers (PC's), on a mobile device and/or in the cloud. Such examples are non-limiting as the smart contracts may be generated at a variety of other devices and/or types thereof. In some embodiments, each smart contract may involve external services at the discretion of the parties. In some embodiments, a range of options may be selected by the parties at the time the smart contract is generated.

Some embodiments provide that a smart contract may be registered with a settlement service provider that is agreed to by the parties. In some embodiments, a settlement service may provide information about the outcome, such as revenue generated, of the venture on which the security is based. In some embodiments, the settlement service may send the information to the counterparties, which may trigger payouts under the terms of the smart contract. For example, the settlement service provider may initiate a bank transfer from the buyer to the seller based on the smart contract. In some embodiments, the process may be automated by software on a computer and/or server controlled by the settlement service. Embodiments herein do not require the funds to be held in any kind of escrow, however, such option is contemplated by this disclosure. For example, embodiments herein are directed to any financial settlement process that may be used in conjunction with the smart contracts as disclosed herein.

Embodiments provide that the settlement transaction may be stored in blockchain to close the contract. In some embodiments, details corresponding to the settlement transaction may be retained for auditing, later scrutiny and/or to ensure that no errors are made.

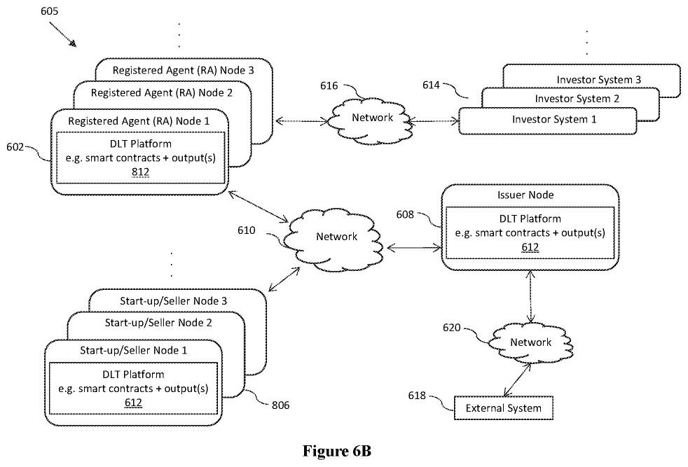

FIGS. 6A and 6B are schematic diagrams illustrating example embodiments of a system comprising nodes and users that may be involved in a smart system for multi-priced venture funding utilizing one or more smart contracts on a distributed ledger technology platform. A node is a connection point in a communications network and allow users to interact with the network. Each node is an endpoint for data transmissions or redistribution. Nodes have either a programmed or engineered capability to recognize, process and forward transmissions to other network nodes As illustrated in FIG. 6A, in some embodiments, a smart platform 600 for administering funding rounds can comprise one or more registered agent (RA) or dealer nodes 602, one or more investor nodes 604, one or more seller nodes 606 for ventures seeking funding, and/or a central authority node 608, which can be in communication with one another through a network 610. The central authority node 608 is held by the issuer of the securities, such as a Securities Management Company (SMC). In some embodiments, one or more of the RA node(s) 602, investor node(s) 604, seller node(s) 606, and central authority node 608, such as node controlled by the issuer SMC, can comprise a DLT platform 612 on which the smart venture funding platform, one or more smart contracts and smart contract outputs thereof, and/or one or more private data sharing channels may be implemented. In some embodiments, the DLT platform 612 can be configured to facilitate the filing, tracking, management, communications, notifications, or the like of the smart platform as described herein. In some embodiments, the system 600 may also include an external system 618 as described below with regard to FIG. 6B.

As illustrated in FIG. 6B, in some embodiments of a smart platform for trading shares in a plurality of funding rounds 605, one or more investor systems 614 may not comprise a DLT platform. Rather, the one or more investor systems 614 can be configured to communicate with one or more RA nodes 602 comprising a DLT platform 612 through a separate network 616, for example through an application programming interface (“API”). As such, in some embodiments, one or more investor systems 614 may not be on the DLT itself. For example, small investors may be able to purchase securities from a registered agent or dealer in the distributed network, who is authorized to negotiate terms and conditions of the smart contracts on behalf of small investors. The RA may negotiate the terms and conditions prior to or after engaging with investors not on the DLT itself. In some embodiments, the RA may be authorized to sell shares outside the distributed system. Further, in some embodiments, a central authority node 608 can be configured to maintain a separate external system 618. In some embodiments, the separate external system 918 can be in communication with the central authority node 608 through a separate network connection 620, such as an API, for example for purposes of maintaining legally valid versions of the securities. In some embodiments, the smart filings on the DLT itself can be the legally valid and canonical version of the filings. In embodiments, the external system may also include modules for managing the securitization that are desirably kept separate from the distributed ledger. For example, owner confidential information and pre-issuance activities such as valuation of and administering securities (e.g. blocks 220 and 250 of FIGS. 2A and 2B and blocks 402 and 404 of FIG. 4) may be held in the separate external system. In other embodiments, the smart security platform may comprise a combination of investors 604 with nodes on the distributed ledger and investors 614 without nodes on the distributed ledger.

In an additional aspect, provided is a method for providing multi-priced venture funding, the method comprising: providing a first price category in which a plurality of first price category shares can be purchased at a first price, wherein the first price category indicates a first known percentage of a target valuation for the initial offering; providing a second price category in which a plurality of second price category shares can be purchased, wherein the second price category indicates a second known percentage of the target valuation, distinct from the first known percentage of the target valuation, and wherein the second price category shares are sold at a second price at an incrementally higher offering price than the first price, wherein the target valuation includes at least a portion of the revenue provided from the plurality of the first price category shares and at least a portion of the revenue provided from the plurality of the second price category shares; wherein the second price category shares are offered for sale at a time after the first price category shares are sold and purchasers of the first price category shares can sell the first price category shares to purchasers of the second price category shares at the second price.

Embodiments of the method include the following, alone or in any combination.

The second price category shares may be offered for sale immediately after the market valuation of the first category shares reaches the second price.

Providing a third price category in which a plurality of third price category shares can be purchased, wherein the third price category indicates a third known percentage of the target valuation, distinct from the first known percentage of the target valuation and distinct from the second known percentage of the valuation, and wherein the third price category shares are sold at a third price at an incrementally higher offering price than the second price, wherein the target valuation includes at least a portion of the revenue provided from the plurality of the first price shares, at least a portion of the revenue provided from the plurality of the second price category shares and at least a portion of the revenue provided from the plurality of the third price category shares; wherein the third price category shares are sold at a time after the second price category shares are sold and purchasers of the first price category shares can sell the first price category shares to purchasers of the third price category shares at the third price and purchasers of the second price category shares can sell the second price category shares to purchasers of the third price category shares at the third price. Notably, the third price category shares are offered for sale after the market valuation of the second category shares reaches the third price.

Offering one or more tranches of a subsequent price category, wherein each subsequent price category comprises a plurality of subsequent price category shares for purchase, wherein the subsequent price category indicates a known percentage of the target valuation, distinct from the percentage of any previous price category, and wherein the subsequent price category shares are sold at a price at an incrementally higher offering price than the price of the preceding price category, wherein the target valuation includes at least a portion of the revenue provided from the plurality of all price category shares; wherein the subsequent price category shares are offered for sale at a time after the preceding price category shares are sold and purchasers of preceding price category shares can sell preceding price category shares to purchasers of the subsequent price category shares at the subsequent price. The subsequent price category shares may be offered for sale after the market valuation of the preceding category shares reaches the subsequent price.

Another aspect provides a computerized system with hardware and specialized software components for developing, executing and administering multi-priced venture funding, the system comprising a non-transitory computer readable storage medium comprising a plurality of computer readable instructions embodied thereon which, when executed by the computerized system, causes the computerized system to: provide a first price category in which a plurality of first price category shares can be purchased at a first price, wherein the first price category indicates a first known percentage of a target valuation for the initial offering; provide a second price category in which a plurality of second price category shares can be purchased, wherein the second price category indicates a second known percentage of the target valuation, distinct from the first known percentage of the target valuation, and wherein the second price category shares are sold at a second price at an incrementally higher offering price than the first price, wherein the target valuation includes at least a portion of the revenue provided from the plurality of the first price category shares and at least a portion of the revenue provided from the plurality of the second price category shares; wherein the second price category shares are offered for sale at a time after the first price category shares are sold and purchasers of the first price category shares can sell the first price category shares to purchasers of the second price category shares at the second price.

Embodiments of the system include the following, alone or in any combination.

The second price category shares for sale after the market valuation of the first category shares reaches the second price.

The system may offer one or more tranches of a subsequent price category, wherein each subsequent price category comprises a plurality of subsequent price category shares for purchase, wherein the subsequent price category indicates a known percentage of the target valuation, distinct from the percentage of any previous price category, and wherein the subsequent price category shares are sold at a price at an incrementally higher offering price than the price of the preceding price category, wherein the target valuation includes at least a portion of the revenue provided from the plurality of all price category shares; wherein the subsequent price category shares are offered for sale at a time after the preceding price category shares are sold and purchasers of preceding price category shares can sell preceding price category shares to purchasers of the subsequent price category shares at the subsequent price.

The subsequent price category shares may be offered for sale after the market valuation of the preceding category shares reaches the subsequent price.

Also provided is a non-transitory computer readable storage medium comprising a plurality of computer readable instructions embodied thereon wherein the instructions, when executed by a computerized system with hardware and specialized software components for developing, executing and administering multi-priced venture funding, cause the computerized system to: provide a first price category in which a plurality of first price category shares can be purchased at a first price, wherein the first price category indicates a first known percentage of a target valuation for the initial offering; provide a second price category in which a plurality of second price category shares can be purchased, wherein the second price category indicates a second known percentage of the target valuation, distinct from the first known percentage of the target valuation, and wherein the second price category shares are sold at a second price at an incrementally higher offering price than the first price, wherein the target valuation includes at least a portion of the revenue provided from the plurality of the first price category shares and at least a portion of the revenue provided from the plurality of the second price category shares; wherein the second price category shares are offered for sale at a time after the first price category shares are sold and purchasers of the first price category shares can sell the first price category shares to purchasers of the second price category shares at the second price.

Embodiments of the non-transitory computer readable storage medium include the following, alone or in any combination.

The second price category shares may be offered for sale after the market valuation of the first category shares reaches the second price.

The computerized system may offer one or more tranches of a subsequent price category, wherein each subsequent price category comprises a plurality of subsequent price category shares for purchase, wherein the subsequent price category indicates a known percentage of the target valuation, distinct from the percentage of any previous price category, and wherein the subsequent price category shares are sold at a price at an incrementally higher offering price than the price of the preceding price category, wherein the target valuation includes at least a portion of the revenue provided from the plurality of all price category shares; wherein the subsequent price category shares are offered for sale at a time after the preceding price category shares are sold and purchasers of preceding price category shares can sell preceding price category shares to purchasers of the subsequent price category shares at the subsequent price.

The subsequent price category shares may be offered after the market valuation of the preceding category shares reaches the subsequent price.

The system and methods described herein may be used for private offerings, initial public offerings or combinations thereof. For example, all tranches may be offered to a limited number of private venture capital entities. In other embodiments early tranches may be offered to a limited number of private venture capital entities, while later tranches may be offered in an initial public offering.

1. A method for providing multi-priced funding, the method comprising:
providing a first round of shares of equity in a private company, wherein each share in the first round available for purchase by one or more first investors at a first fixed price, wherein the first round of shares at the first fixed price become unavailable when a first threshold of capital is raised, and
providing a second round of shares of equity in the same company, wherein each share in the second round is available for purchase by one or more second investors at a second fixed price, the second fixed price being greater than the first fixed price associated with the first round of shares, and further wherein the one or more first investors have an option to offer their first shares at the greater price.

2. The method of claim 1, wherein the second round of shares are available for investment by the one or more second investors until a second threshold of capital is raised.

3. The method of claim 2, wherein the first threshold of capital represents a first percentage of a target valuation of the company.

4. The method of claim 3, wherein the second threshold of capital represents a second percentage of a target valuation of the company.

5. The method of claim 4, wherein the first and second thresholds represent 100% of the target valuation of the company.

6. The method of claim 1, wherein the method includes a third round of shares of equity at a third price, the third price being greater than the second price associated with the second round of shares.

7. The method of claim 6, wherein the third round of shares are available only when a second threshold of capital is raised, and further wherein the first and second investors each have the option to trade their shares to investors at the third price.

8. The method of claim 1 conducted by a distributed networked computer system, the method comprising:
a central processor
receiving, from a first networked node, a first bid for one or more shares of a first round of shares from a first investor;
determining a fractional amount of the shares of the first round to allocate to the first investor based on the first bid;
determining that a first threshold of capital is raised and closing availability of the first round of shares;
providing a second round of shares for sale to a second investor after the first threshold is reached;
receiving, from a second networked node, a second bid for one or more shares of the second round of shares from the second investor;
allocating, by one or more processors, the fractional amount of the first round of shares to the first inventor and the fractional amount of shares of the second round to the second inventor;
recording in a distributed ledger, wherein the distributed ledger is accessible by the first networked node and the second networked node, bids for the one or more shares of the first round of shares and the one or more shares of the second round of shares;
respective allocated shares determined by the central processor; and
execution of a smart contract accessible to the first networked node or the second networked node, wherein the smart contract comprises:
acceptance, by the private company, of the bids from the first investor or the bids from the second investor; and
a plurality of predetermined electronic actions for generating a smart contract output when the bids are accepted, wherein the smart contract generates terms and conditions between the private company and the first investor and between the private company and the second investor automatically based on whether the shares are from the first round or second round.

9. A distributed networked computer system for providing multi-priced venture funding of equity in a private company, the distributed network computer system comprising
a non-transitory computer readable storage medium having program instructions embodied therewith; and
one or more processors configured to execute the program instructions to cause the computer system to:
receive by a central processor, from a first networked node, a first bid for one or more shares of a first round of shares in the private company from a first investor;
determine a fractional amount of the shares of the first round to allocate to the first investor based on the first bid;
determine that a first threshold of capital is raised and closing availability of the first round of shares;
provide a second round of shares in the private company for sale to a second investor after the first threshold is reached;
receive, from a second networked node, a second bid for one or more shares of the second round of shares from the second investor;
allocate, by one or more processors, the fractional amount of the first round of shares to the first inventor and the fractional amount of shares of the second round to the second inventor;
a distributed ledger for recording bids for the shares and respective allocated shares determined by the central processor, wherein the distributed ledger is accessible by the first networked node and the second networked node; and
a smart contract accessible to the first networked node and the second networked node, wherein the smart contract comprises:
acceptance, by the private company, of the bids from the first investor and the bids from the second investor; and
a plurality of predetermined electronic actions for generating a smart contract output when the bids are accepted, wherein the smart contract generates terms and conditions between the private company and the first investor and between the private company and the second investor automatically based on whether the shares are from the first round or second round; and further wherein the execution of the smart contract is recorded to the distributed ledger.

10. The distributed networked computer system of claim 9, wherein each share in the first round is available for purchase by one or more first investors at a first fixed price, wherein the first round of shares at the first fixed price become unavailable when the first threshold of capital is raised, and wherein each share in the second round is available for purchase by one or more second investors at a second fixed price, the second fixed price being greater than the first fixed price associated with the first round of shares, and further wherein the one or more first investors have an option to offer their first shares at the greater price.

11. The distributed networked computer system of claim 10, wherein the first threshold of capital represents a first percentage of a target valuation of the company.

12. The distributed networked computer system of claim 10 wherein the second round of shares are available for investment by the one or more second investors until a second threshold of capital is raised.

13. The distributed networked computer system of claim 12 wherein the second threshold of capital represents a second percentage of a target valuation of the company.

14. The distributed networked computer system of claim 13, wherein the instructions cause the distributed networked computer system to provide a third round of shares of equity at a third price, the third price being greater than the second price associated with the second round of shares, wherein the third round of shares are available only when a second threshold of capital is raised.

15. A non-transitory computer readable storage medium comprising a plurality of computer readable instructions embodied thereon wherein the instructions, when executed by a distributed networked computer system for providing multi-priced venture funding of equity in a private company, cause the distributed networked computer system to:
cause a central processor to
receive, from a first networked node, a first bid for one or more shares of a first round of shares in the private company from a first investor;
determine a fractional amount of the shares of the first round to allocate to the first investor based on the first bid;
determine that a first threshold of capital is raised and closing availability of the first round of shares;
provide a second round of shares in the private company for sale to a second investor after the first threshold is reached;
receive, from a second networked node, a second bid for one or more shares of the second round of shares from the second investor;
allocate, by one or more processors, the fractional amount of the first round of shares to the first inventor and the fractional amount of shares of the second round to the second inventor; and
record in a distributed ledger, wherein the distributed ledger is accessible by the first networked node and the second networked node,
bids for the one or more shares of the first round of shares and the one or more shares of the second round of shares;
respective allocated shares determined by the central processor; and
execution of a smart contract accessible to the first networked node and the second networked node, wherein the smart contract comprises:
acceptance, by the private company, of the bids from the first investor and the bids from the second investor; and
a plurality of predetermined electronic actions for generating a smart contract output when the bids are accepted, wherein the smart contract generates terms and conditions between the private company and the first investor and between the private company and the second investor automatically based on whether the shares are from the first round or second round.

16. The non-transitory computer readable storage medium of claim 15, wherein each share in the first round is available for purchase by one or more first investors at a first fixed price, wherein the first round of shares at the first fixed price become unavailable when the first threshold of capital is raised, and wherein each share in the second round is available for purchase by one or more second investors at a second fixed price, the second fixed price being greater than the first fixed price associated with the first round of shares, and further wherein the one or more first investors have an option to offer their first shares at the greater price.

17. The non-transitory computer readable storage medium of claim 16, wherein the first threshold of capital represents a first percentage of a target valuation of the company.

18. The non-transitory computer readable storage medium of claim 15 wherein the second round of shares are available for investment by the one or more second investors until a second threshold of capital is raised.

19. The non-transitory computer readable storage medium of claim 18, wherein the second threshold of capital represents a second percentage of a target valuation of the company.

20. The non-transitory computer readable storage medium of claim 18, wherein the instructions cause the distributed networked computer system to provide a third round of shares of equity at a third price, the third price being greater than the second price associated with the second round of shares, wherein the third round of shares are available only when a second threshold of capital is raised.
